(19) United States
(12) Patent Application Publication
(10) Pub. No.: US 2022/0405681 A1
(43) Pub. Date: Dec. 22, 2022

(54) PERSONAL INTRODUCTION INFORMATION GENERATING METHOD, COMPUTING DEVICE USING THE SAME, AND STORAGE MEDIUM

(71) Applicant: NOZO GROUP CO., LTD., Shenzhen (CN)

(72) Inventor: Tianqing MENG, Shenzhen (CN)

(21) Appl. No.: 17/748,050

(22) Filed: May 19, 2022

(30) Foreign Application Priority Data
Jun. 18, 2021 (CN) 202110680713.7
Jul. 28, 2021 (CN) 202110858078.7

(51) Int. Cl. G06Q 10/06; G06Q 50/18; G06N 3/08

(52) U.S. Cl. CPC G06Q 10/06398; G06Q 50/18; G06Q 10/063112; G06N 3/08

(57) ABSTRACT

The present disclosure provides a personal introduction information generating method. The method includes: obtaining basic information of an attorney; establishing a communicational connection with a third-party database to extract all patent case data corresponding to the attorney; counting a historical approval rate of the attorney based on all the patent case data to extract to-be-evaluated patent cases; evaluating the to-be-evaluated patent cases to obtain a review result; generating personal introduction information corresponding to the attorney using a preset template according to the historical approval rate of the attorney and the review result. The method realizes the accurate and comprehensive obtaining of information of patent attorneys. In addition, a computing device and a storage medium are also provided.

### CROSS REFERENCE TO RELATED APPLICATIONS

The present disclosure claims priority to Chinese Patent Application No. 202110680713.7, filed Jun. 18, 2021 and Chinese Patent Application No. 202110858078.7, filed Jul. 28, 2021, which is hereby incorporated by reference herein as if set forth in its entirety.

### BACKGROUND

### 1. Technical Field

The present disclosure relates to information processing technology, and particularly to a personal introduction information generating method, a computing device using the same, and a storage medium.

### 2. Description of Related Art

With the vigorous development of science and technology, intellectual property rights are increasingly valued by enterprises. As a kind of intangible asset, patents have become an important competitive resource for enterprises. Patent documents are a kind of professional legal documents, and the patent applicants often need to be realized by entrusting a patent agency because the drafting of the patent documents needs to be performed by the patent attorney in the agency.

However, there is a serious information asymmetry in the patent agency industry at present. Whenever an applicant wants to know the information (e.g., the professional level) of a patent attorney, she/he can only achieve it through the introduction information about the patent attorney that is provided by the agency. However, the method to know the information of the patent attorney is not only inefficient, but also cannot guarantee that the information of the patent attorney provided by the agency is authentic and credible.

### SUMMARY

The purpose of the present disclosure is to provide a method that can accurately obtain the information of patent attorneys so as to solve the problem of the low authenticity of personal introduction information of patent attorneys in this industry.

For achieving the above-mentioned object, in the first aspect, the present disclosure provides a personal introduction information generating method for an information processing platform, including:

obtaining basic information of an attorney, where the basic information includes identification information of the attorney;

establishing a communicational connection with a third-party database stored with patent case information including the identification information of the attorney;

calculating a historical approval rate related to the attorney within a preset time by processing all patent case data corresponding to the attorney using a preset patent case data processing model;

extracting a preset number of to-be-evaluated patent cases within a preset period in years from all the patent case data corresponding to the attorney;

sending the to-be-evaluated patent cases to a corresponding expert for review to receive a review result returned by the expert; and

generating personal introduction information corresponding to the attorney using a preset template according to the historical approval rate of the attorney and the review result.

For achieving the above-mentioned object, in the second aspect, a computer-readable storage medium storing computer program(s) is provided. When the computer program(s) are executed by processor(s), the processor(s) are made to perform steps of:

obtaining basic information of an attorney, where the basic information includes identification information of the attorney;

establishing a communicational connection with a third-party database stored with patent case information including the identification information of the attorney;

calculating a historical approval rate related to the attorney within a preset time by processing all patent case data corresponding to the attorney using a preset patent case data processing model;

extracting a preset number of to-be-evaluated patent cases within a preset period in years from all the patent case data corresponding to the attorney;

sending the to-be-evaluated patent cases to a corresponding expert for review to receive a review result returned by the expert; and

generating personal introduction information corresponding to the attorney using a preset template according to the historical approval rate of the attorney and the review result.

For achieving the above-mentioned object, in the third aspect, a computing device including storage(s) and processor(s) is provided. The storage(s) store computer program(s). When the computer program(s) are executed by the processor(s), the processor(s) are made to perform steps of:

obtaining basic information of an attorney, where the basic information includes identification information of the attorney;

establishing a communicational connection with a third-party database stored with patent case information including the identification information of the attorney;

calculating a historical approval rate related to the attorney within a preset time by processing all patent case data corresponding to the attorney using a preset patent case data processing model;

extracting a preset number of to-be-evaluated patent cases within a preset period in years from all the patent case data corresponding to the attorney;

sending the to-be-evaluated patent cases to a corresponding expert for review to receive a review result returned by the expert; and

generating personal introduction information corresponding to the attorney using a preset template according to the historical approval rate of the attorney and the review result.

The above-mentioned personal introduction information generating method, computing device and storage medium first obtain all the patent case data of historical cases of the attorney by interacting with the third-party database according to the basic information of the attorney, and count the historical approval rate of the attorney by analyzing all the patent case data corresponding to the attorney, and further randomly select the preset number of the to-be-evaluated patent cases within the preset period in years to send to the experts of the corresponding technology for evaluation so as to receive the returned review result.

In the method, the authentic patent case data of the historical cases of the attorney can be grabbed based on the interaction with the third-party database, the authentic historical approval rate of the attorney can be obtained based on the authentic patent case data, and the authentic review result can be obtained by extracting the real patent cases for expert review. Finally, the personal introduction information of the attorney is generated by synthesizing the historical approval rate corresponding to the attorney and the review result. The generated personal introduction information of the attorney is not only authentic and credible, but also comprehensive, which is convenient for the applicant to comprehensively and accurately understand the professional level of the attorney according to the personal introduction information of the attorney. In addition, the personal introduction information of the attorney is open to the outside world and can be obtained quickly on a terminal device by the applicant. Furthermore, the applicant can view the personal introduction information of all patent attorneys, rather than the patent attorneys of a certain agency.

### BRIEF DESCRIPTION OF THE DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a personal introduction information generating method according to an embodiment of the present disclosure.

FIG. 2 is a flow chart of a method for determining the professional level of an attorney according to an embodiment of the present disclosure.

FIG. 3 is a flow chart of a personal introduction information recommending method according to an embodiment of the present disclosure.

FIG. 4 is a flow chart of a method for calculating a degree of matching with each candidate attorney according to an embodiment of the present disclosure.

FIG. 5 is a flow chart of an information interaction method according to an embodiment of the present disclosure.

FIG. 6 is a timing diagram of the process of information exchange according to an embodiment of the present disclosure.

FIG. 7 is a schematic block diagram of the structure of a personal introduction information generating apparatus according to an embodiment of the present disclosure.

FIG. 8 is a schematic block diagram of the structure of a personal introduction information recommending apparatus according to an embodiment of the present disclosure.

FIG. 9 is a schematic block diagram of the structure of an information interaction apparatus according to an embodiment of the present disclosure.

FIG. 10 is a schematic block diagram of the internal structure of a computing device according to an embodiment of the present disclosure.

### DETAILED DESCRIPTION

It should be understood that, the embodiments described herein are only for explaining the present disclosure, but not to limit the present disclosure.

The technical solutions in the embodiments of the present disclosure will be clearly and completely described below in conjunction with the drawings in the embodiments of the present disclosure. Apparently, the following embodiments are only part of the embodiments of the present disclosure, not all of the embodiments of the present disclosure. All other embodiments obtained by those skilled in the art without creative efforts are within the scope of the present disclosure.

It should be noted that, the terms “composing”, “including” and “having” in the description and claims of the present disclosure and the above-mentioned drawings as well as any modifications thereof are intended to cover non-exclusive inclusion. For example, a process, method, system, product or apparatus (device) including a series of steps or units is not limited to the listed steps or units, but optionally further includes unlisted steps or units, or includes other steps or units inherent to the processes, method, product or apparatus. For the terms in the claims, description and drawings of the present disclosure, the relational terms such as “first” and “second” are only for distinguishing one entity/operation/object from another entity/operation/object, and are not necessarily requiring or implying any such actual relationship or ordering between these entities/operations/objects.

In the present disclosure, “embodiment” means that a particular feature, structure, or characteristic described in connection with the embodiment can be included in at least one embodiment of the present disclosure. The appearance of the term in various places in this specification is not necessarily all referring to the same embodiment, nor is it a separate or alternative embodiment that is mutually exclusive with other embodiments. It is explicitly and implicitly understood by those skilled in the art that the embodiments described herein may be combined with other embodiments.

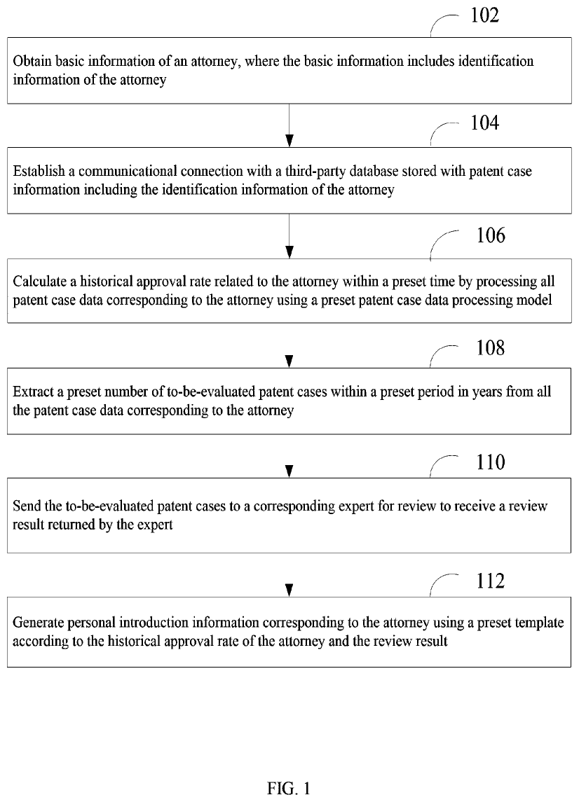

FIG. 1 is a flow chart of a personal introduction information generating method according to an embodiment of the present disclosure. As shown in FIG. 1, to display personal introduction information of patent attorneys in an authentic manner, a personal introduction information generating method which may be applied to an information processing platform such as (a server of) a website is provided. The method may include the following steps.

102: obtaining basic information of an attorney, where the basic information includes identification information of the attorney.

In which, the “attorney” here refers to a person engaged in patent agency work that is also known as “patent attorney” or “patent agent”. The basic information of the attorney includes the identification information of the attorney that is for determining the identity of the attorney. In one embodiment, the name and surname of the attorney may be directly used as the identification information of the attorney, or the qualification certificate number of the attorney may be used as the identification information of the attorney. In another embodiment, to determine the identification information of the attorney more accurately, the name and surname of the attorney+the practice experience of the attorney may be used as the identification information of the attorney, where the practice experience includes the related agency name(s) each corresponding to one practice period of the attorney. In addition, in addition to the identification information of the attorney, the basic information of the attorney may further include other personal information such as gender information, education information, profession information, attorney qualification certificate information, attorney practice certificate information, attorney practice duration in years, and agency profession. The practice experience may include the agency and the corresponding duration of the practice of the attorney. For example, for the attorney Li San, there is the practice in agency A during January 2012-July 2018, and the practice in agency B during August 2018-April 2021. At present, the agency profession of the attorney in this industry is mainly divided into four kinds, namely software and communication, electronics, machinery, and biology and chemistry.

There are many ways to obtain the basic information of the attorney. In one embodiment, the basic information of the attorney may be obtained directly from registration information of the attorney. The attorney may register with the real name on the information processing platform, where the related personal information needs to be filled out when registering. In another embodiment, the basic information of the attorney may be grabbed by interacting with a third-party platform. For example, the practice experience of the attorney may be searched from the website of the All-China Agents Association, and academic information, profession information and the like of the attorney may be searched from the “Xuexin Network”.

104: establishing a communicational connection with a third-party database stored with patent case information including the identification information of the attorney.

In which, the communicational connection may be a database connection which allows a client (i.e., the information processing platform) to communicate with a database server (i.e., the server of the third-party database). The third-party database refers to a database that stores the patent case information, which may be the patent search database of the China National Intellectual Property Administration, or other patent search databases such as PatSnap, Baiten, and incoPat. For a case submitted by an agency, its patent case information will include the identification information of the attorney. For example, each patent case information will include an agency name and the name and surname of an attorney.

106: calculating a historical approval rate related to the attorney within a preset time by processing all patent case data corresponding to the attorney using a preset patent case data processing model.

In which, the patent case data processing model for performing batch processing on all the patent case data corresponding to the attorney. The patent case data may be stored locally in the information processing platform, or stored in the above-mentioned third-party database (and grabbed by the information processing platform from the above-mentioned third-party database). The legal status of each patent case can be extracted through the patent case data processing model. The legal status includes one of for statuses, namely approved, examining, denied, and withdrawn. The status of withdrawn is divided into active withdrawn and deemed withdrawn. The preset time may be customized. For example, the time since the attorney has been in business may be used as the preset time, or the last five years may be used as the preset time.

In one embodiment, the historical approval rate may be obtained by calculating the ratio of the number of approved cases to that of closed cases, where the closed cases may include approved cases, denied cases and withdrawn cases. For example, if the number of approved cases is 120 and that of closed cases is 200, the calculated historical approval rate will be 120/200=60%.

In one embodiment, the calculation of the approval rate may be calculated only based on invention patent cases, because utility model patent cases and design patent cases do not involve substantive examination and their approval rate cannot accurately reflect the professional level of the attorney. The patent case data processing model may first extract invention patents by case type, then extract the legal status of each invention patent, and finally count the historical approval rate of the attorney based on the legal status of each invention patent. It will be helpful to accurately evaluate the professional level of the attorney by counting the approval rate based on invention patent cases.

In another embodiment, to better reflect the current professional level of the attorney, a preset number (e.g., 100) of closed cases closest to the current time may be selected, and the historical approval rate that best reflects the current professional level of the attorney may be calculated according to the number of approved cases, the number of denied cases and the number of withdrawn cases in the closed cases.

108: extracting a preset number of to-be-evaluated patent cases within a preset period in years from all the patent case data corresponding to the attorney.

In which, the to-be-evaluated patent cases may be the patent cases that are selected randomly for an expert to evaluate the drafting quality of the attorney. Since the professional level of the attorney is generally gradually improved with the accumulation of experience, to truly reflect the current professional level of the attorney, a preset number (e.g., 3) of patent cases may be extracted from the patent case data within the preset period in years (e.g., the past three years) to take as the to-be-evaluated patent cases, so as to facilitate the accurate evaluation of the current professional level of the attorney.

110: sending the to-be-evaluated patent cases to a corresponding expert for review to receive a review result returned by the expert.

In which, to evaluate the drafting quality of the attorney more accurately, it may need to send the to-be-evaluated patent cases to the expert of the corresponding technology for review, and receive the returned review result which may be a score or a grade. When there are a plurality of to-be-evaluated patent cases, it may need to synthesize the review results corresponding to the to-be-evaluated patent cases. For example, when there are three to-be-evaluated patent cases, the average score of the three pending patent cases may be taken.

In another embodiment, to accurately match the expert for review, it may need to perform technical analysis on the to-be-evaluated patent cases to determine technologies) to which the to-be-evaluated patent cases belongs, and then send the to-be-evaluated patent cases to the expert corresponding to the technologies) for review. In which, the division of technologies may be according to specific technologies. For example, the technology may be determined according to the technology classification number, where the technology classification number itself represents the technology to which it belongs. For example, the technology classification number G01 represents the technology of measurement and testing, and the technology classification number G02 represents the technology of optics. In another embodiment, the technology may be determined according to the technology classification number and the technical keywords at the same time, and the combination of the technology classification number+the technical keywords may obtain a more subdivided technology. For example, if the technology classification number indicates program control, and the technical keyword is temperature control, the determined technology will be software-based temperature control.

112: generating personal introduction information corresponding to the attorney using a preset template according to the historical approval rate of the attorney and the review result.

In one embodiment, the historical approval rate and review result of the export of the cases of the attorney are counted, then the personal introduction information is generated. The personal introduction information may include the historical approval rate and the review result of the expert, so that the information of the attorney can be shown more comprehensively and authentically.

In which, the personal introduction information of the attorney may include the historical approval rate and the review result. In addition, to show the professional level of the attorney more comprehensively, the generated personal introduction information of the patent attorney may further include the main applicant(s) of historical cases of the attorney and the main technical field(s) of the historical cases. Furthermore, other information such as the agency profession of the attorney may also be included. At present, the agency profession of the attorney in this industry is mainly divided into tour kinds, namely software and communication, electronics, machinery, and biology and chemistry. The agency profession may also be adjusted according to actual needs by, for example, further refining the corresponding agency profession.

In this method, the authentic patent case data of the historical cases of the attorney can be grabbed based on the interaction with the third-party database, the authentic historical approval rate of the attorney can be obtained based on the authentic patent case data, and the authentic review result can be obtained by extracting the real patent cases for expert review. Finally, the personal introduction information of the attorney is generated by synthesizing the historical approval rate corresponding to the attorney and the review result. The generated personal introduction information of the attorney is not only authentic and credible, but also comprehensive, which is convenient for the applicant to comprehensively and accurately understand the professional level of the attorney according to the personal introduction information of the attorney. In addition, the personal introduction information of the attorney is open to the outside world and can be obtained quickly on a terminal device by the applicant. Furthermore, the applicant can view the personal introduction information of all patent attorneys, rather than the patent attorneys of a certain agency.

In one embodiment, the generating personal introduction information corresponding to the attorney using a preset template according to the historical approval rate of the attorney and the review result (step 112) may include: determining a professional level of the attorney using a preset algorithm according to the historical approval rate of the attorney and the review result; and generating the personal introduction information corresponding to the attorney using a preset template according to the professional level of the attorney.

In which, the historical approval rate of the attorney can accurately reflect the professional level, the review results can accurately reflect the drafting quality of the cases, and the professional level of the attorney can be shown accurately by synthesizing the results of the two. In one embodiment, the two may be synthesized by means of weighted summation. The personal introduction information may include the professional level of the attorney, and may also include the historical approval rate and the review result.

In one embodiment the practice duration in years of the attorney and the total number of the historical cases is obtained to use as inputs of a weight determination model which is trained based on a deep neural network model, a first weight of the historical approval rate corresponding to the attorney and a second weight of the review result that are outputted by the weight determination model is obtained, and the professional level of the attorney is determined according to the historical approval rate find the first weight as well as the review result and the second weight.

In another embodiment, historical service evaluation information of the attorney may also be obtained.

In which, the historical service evaluation information refers to the evaluation information of the customers of the historical service of the attorney on the profession and service of the attorney. The historical service evaluation information may be a score or a grade. For example, the grade may be divided into very good, good, average, and bad. The historical service evaluation information of the attorney can authentically reflect the service quality of the attorney including service attitude and professional recognition. Then, according to the historical approval rate of the attorney, the review result and the historical evaluation information, the professional level of the attorney may be determined using the preset algorithm. That is, the results of the three are synthesized to perform level division, and the method can more accurately achieve the professional grades of the attorney.

It should be noted that, for the attorney who does not have cases on the information processing platform, there is no historical service evaluation information, that is, the obtained historical service evaluation information may be null. When the historical service evaluation information is null, the historical evaluation information may be set as a default value, or its weight may be set to 0 while the weight of the other two may be increased. In one embodiment, the level division of the professional level may be customized according to actual needs. For example, the professional level may be divided into five levels, namely AAA, AA+, AA, AA−, and A. Or, 6 levels may also be used. In addition, the expression form of the levels may also be customized as, for example, stars for lighting up.

In one embodiment the main applicant of the historical case of the attorney and the main technical field of the historical case are obtained by: obtaining applicants and technical fields of historical patent cases of the attorney by analyzing all the patent case data corresponding to the attorney.

In which, when there are many applicants and technical fields in the historical cases, the mam applicants and main technical fields may be selected therefrom. The main applicants refer to the preset number of applicants selected as the main applicant by sorting the number of cases of each applicant in the historical cases from the most to the least. For example, in the historical cases, if company A has 10 cases, company B has 20 cases, company C has 34 cases, company D has 5 cases and company E has 12 cases, the applicants will be sorted as company C, company B, company E, company A and company D according to the number of patent cases, and then the first three applicants can be selected as the main applicants, namely company C, company B and company E. The main technical fields refer to the technical fields of the preset number (e.g., the first three) selected as the main technical fields by sorting the number of cases of each technical field in the historical cases. By selecting the main applicants and the main technical fields, it will be convenient for the subsequent presentation of the attorney information in a more focused manner.

In one embodiment the above-mentioned method may further include: sending the generated personal introduction information to a terminal device for display. That is, after logging into the information processing platform, the terminal device can view the personal introduction information of the attorney. It solves the problem in this industry that the personal introduction information of the attorney cannot be obtained accurately and quickly.

The above-mentioned personal introduction information generating method first obtains all the patent case data of the historical cases of the attorney by interacting with the third-party database according to the basic information of the attorney, and counts the historical approval rate of the attorney by analyzing all the patent case data corresponding to the attorney, and further randomly selects the preset number of the to-be-evaluated patent cases within the preset period in years to send to the experts of the corresponding technology for evaluation so as to receive the returned review result. Finally, the professional level of the attorney is calculated according to the historical approval rate corresponding to the attorney and the review result.

In this method, the authentic patent case data of the historical cases of the attorney can be grabbed based on the interaction with the third-party database, the authentic historical approval rate of the attorney can be obtained based on the authentic patent case data, and the authentic review result can be obtained by extracting the real patent cases for expert review. Finally, the professional level of the attorney is determined by synthesizing the historical approval rate corresponding to the attorney and the review result, where the determination of the professional level is authentic and credible. In addition, according to the professional level of the attorney, the personal introduction information of the attorney is generated using the preset template. The generated personal introduction information of the attorney is not only authentic and credible, but also comprehensive, which is convenient for the applicant to comprehensively and accurately understand the professional level of the attorney according to the personal introduction information of the attorney. In addition, the personal introduction information of the attorney is open to the outside world and can be obtained quickly on a terminal device by the applicant. Furthermore, the applicant can view the personal introduction information of all patent attorneys, rather than the patent attorneys of a certain agency.

In one embodiment, the identification information of the attorney includes a name and surname of the attorney and a practice experience of the attorney, and the practice experience includes one or more agency names each corresponding to one practice period of the attorney; and before the calculating the historical approval rate related to the attorney within the preset time by processing all the patent case data corresponding to the attorney using the preset patent case data processing model (step 106), the method further includes: extracting all the patent case data corresponding to the attorney front the third-party database according to the name and surname of the attorney and the practice experience of the attorney.

In which, since it is very likely that there are attorneys have the same name and the same surname, it may be inaccurate to extract the patent case data only based on the name and surname of the attorney. Therefore, in one embodiment, to ensure the accurate extraction of the patent case data, all the patent case data corresponding to the attorney may be extracted from the third-party database according to the name and surname of the attorney and the practice experience of the attorney simultaneously. The practice experience of the attorney may include the agency and the corresponding duration of the practice of the attorney. Therefore, it is necessary to define an extraction condition according to the practice experience of the attorney, and extract all the patent case data corresponding to the attorney from the third-party database with “name and surname+time period+agency” as the extraction condition.

In one embodiment, the basic information may further include agency profession, and the extracting the preset number of to-be-evaluated patent cases within the preset period in years from all the patent case data corresponding to the attorney (step 108) may include: selecting candidate patent case data matching the agency profession from all the patent case data corresponding to the attorney; and extracting the to-be-evaluated patent cases within the preset period in years from the candidate patent case data.

In which, the agency profession refers to the technology that the attorney is familiar with, which is mainly divided into four kinds, namely software and communication, electronics, machinery, and biology and chemistry. To more accurately reflect the professional level of the attorney in her/his agency profession, when extracting the to-be-evaluated patent cases, the patent cases matching her/his agency profession will be selected. The candidate patent case data matching the agency profession will be selected first, and then several to-be-evaluated patent cases will be randomly selected from the candidate patent cases. By matching with the agency profession, the to-be-evaluated patent cases that can better reflect the professional level of the attorney can be selected, which is conducive to subsequent obtaining more accurate review results.

In one embodiment, the calculating the historical approval rate related to the attorney within the preset time by processing all patent case data corresponding to the attorney using the preset patent case data processing model (step 106) may include: extracting a legal status of each of patent cases in all the patent case data corresponding to the attorney using the preset patent case data processing model, where the legal status includes one of approved, examining, denied, and withdrawn, and the patent case data processing model is for determining a regular expression corresponding to the legal status and extracting the legal status of the patent case based on the regular expression; counting a number of the patent cases with the legal status of approved, a number of the patent cases with the legal status of denied, and a number of the patent cases with the legal status of withdrawn; and calculating the historical approval rate according to the number of the patent cases, the number of the patent cases, and the number of the patent cases.

In which, the patent case data processing model adopts a regular expression when extracting the legal status of the case. The regular expression is a pattern for describing the match of strings. The corresponding legal status is extracted from each case by determining the regular expression corresponding to the legal status, and the historical approval rate is calculated according to the extracted number of approved cases, number of denied cases, and number of withdrawn cases. The historical approval rate=the number of approved cases/(the number of approved cases+the number of denied cases+the number of withdrawn cases).

In one embodiment, the counting the number of the patent cases with the legal status of approved, the number of the patent cases with the legal status of denied, and the number of the patent cases with the legal status of withdrawn may include: counting the number of the patent cases, the number of the patent cases and the number of the patent cases in a preset number of closed cases closest to a current time. The calculating the historical approval rate according to the number of the patent cases, the number of the patent cases, and the number of the patent cases may include: calculating a latest historical approval rate according to the number of the patent cases, the number of the patent cases and the number of the patent cases in the preset number of closed cases closest to the current time.

In which, the closed cases may include approved cases, denied cases, and withdrawn cases. To better reflect the current professional level of the attorney, the approval rate of the preset number (e.g., 100) of the closed cases closest to the current time may be used as the historical approval rate. The historical approval rate is dynamically calculated and is continuously updated over time, so that the professional level of the attorney can be reflected in time.

In one embodiment, the counting the number of the patent cases with the legal status of approved, the number of the patent cases with the legal status of denied, and the number of the patent cases with the legal status of withdrawn may include: selecting candidate patent cases each having a filing date within a preset time period from the patent cases in all the patent case data; and counting the number of the patent cases with the legal status of approved, the number of the patent cases with the legal status of denied, and the number of the patent cases with the legal status of withdrawn in the candidate patent cases. The calculating the historical approval rate according to the number of the patent cases, the number of the patent cases, and the number of the patent cases may include: calculating the historical approval rate corresponding to the preset time period according to the number of the patent cases with the legal status of approved, the number of the patent cases with the legal status of denied, and the number of the patent cases with the legal status of withdrawn in the candidate patent cases.

In which, to more accurately reflect the current professional level of the attorney, when calculating the historical approval rate, the approval rate of the cases within the preset time period may be counted. The preset time period may refer to the time period with the application date being a specific year in the time period, because the period of patent examination is relatively long and generally takes more than one year or even three years. Therefore, the cases with the application date in the past three years can be selected first, and then count the approval state including the number of approved cases, the number of denied cased, and the number of withdrawn cases, of the candidate patent cases with the filing date within the past three years, so as to reflect the professional level of the attorney in the past three years, and the calculated approval rate will be closer to the current professional level of the attorney.

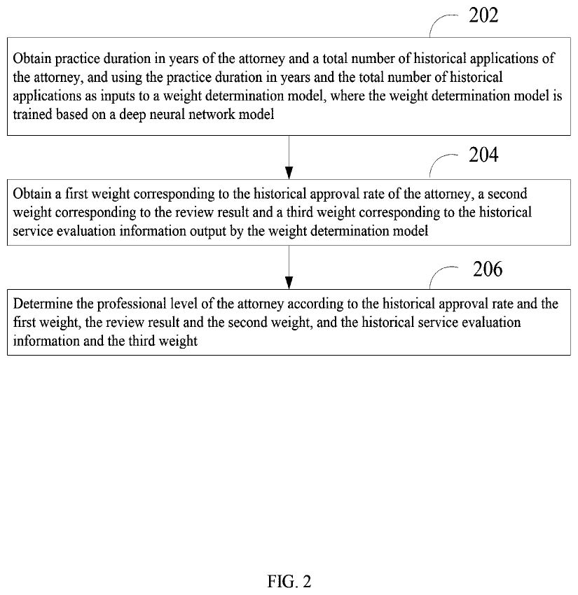

FIG. 2 is a flow chart of a method for determining the professional level of an attorney according to an embodiment of the present disclosure. As shown in FIG. 2, in one embodiment, the determining the professional level of the attorney using the preset algorithm according to the historical approval rate of the attorney, the review result, and the historical service evaluation information may include the following steps.

202: obtaining practice duration in years of the attorney and a total number of historical applications of the attorney, and using the practice duration in years and the total number of historical applications as inputs to a weight determination model, where the weight determination model is trained based on a deep neural network model.

In which, in order to more accurately reflect the real professional level of the attorney, it may need to adjust the weights of the above-mentioned historical approval rate, review result and historical service evaluation information according to the practice duration in years of the attorney and the total number of historical applications. The adjustment is made according to the weight determination model obtained by training.

The weight determination module is obtained by training (and learning) based on the deep neural network model. The weight determination model is trained using the supervised training method, and training data needs to be created. The training data is the practice duration in years of the attorney and the total number of historical applications. Each corresponding manually labeled weight is used as a label for training, and then the parameters in the weight determination model are continuously adjusted using the gradient descent method based on the set loss function until the model reaches the convergence condition.

204: obtaining a first weight corresponding to the historical approval rate of the attorney, a second weight corresponding to the review result and a third weight corresponding to the historical service evaluation information output by the weight determination model.

In which, the first weight, second weight and third weight that are output by the weight determination model are obtained. The first weight reflects the influence of the historical approval rate on the professional level of the attorney, the second weight reflects the influence of the review result on the professional level of the attorney, and the third weight reflects the influence of the historical evaluation information on the professional level of the attorney. Generally speaking, the attorney with a shorter practice duration in years has a relatively larger weight on the review result and a relatively smaller weight on the historical approval rate and historical service evaluation information, because the patent examination cycle is long and the historical approval rate of the attorney with a shorter practice duration in years is relatively large or even have no relevant data yet. Similarly, the corresponding historical service evaluation information will be less, so the reference is not meaningful. As the practice duration in years increase and the total number of cases increases, the weights of the historical approval rate and historical service evaluation information will increase correspondingly.

206: determining the professional level of the attorney according to the historical approval rate and the first weight, the review result and the second weight, and the historical service evaluation information and the third weight.

In which, after determining the first weight corresponding to the historical approval rate, the second weight corresponding to the review result, and the third weight corresponding to the historical service evaluation information, the professional level of the attorney may be determined by using the weighted summation. In the specific calculation, the historical approval rate, review results and historical service evaluation information may be converted into fractions. After the synthesized fractions are calculated, the professional level of the attorney may be determined according to the synthesized fractions. For example, there may be divided into five levels. By using the weight determination model to output the weights of the historical approval rate, review result and historical service evaluation information, and calculating the professional level of the attorney through the weighted summation, the professional level of the attorney can be more authentically reflected.

In one embodiment, the extracting all the patent case data corresponding to the attorney from the third-party database according to the name and surname of the attorney and the practice experience of the attorney may include: determining target search conditions according to the name and surname of the attorney and the practice experience of the attorney, where the target search conditions include the name and surname of the attorney and the one or more agency names and the corresponding practice period; and extracting all the patent case data corresponding to the attorney from the third-party database according to the target search conditions.

In which, to more accurately grab all the patent case data corresponding to the attorney, accurate target search conditions are required. The target search conditions need to include the name and surname of the attorney+the name of the agency for practicing the corresponding practice duration. By setting the target search conditions, the interference caused by the same name and surname can be eliminated as much as possible. As a result, it will be more conducive to accurately obtain all the patent case data corresponding to the attorney.

In one embodiment, the perform technical analysis on the to-be-evaluated patent cases to determine technolog(ies) to which the to-be-evaluated patent cases belongs may include: obtaining the technology classification number and field keywords corresponding to the to-be-evaluated patent cases; and determining the technolog(ies) to which the to-be-evaluated patent cases belongs according to the technology classification number and the field keywords.

In which, the field keywords refer to the fields in which the technology is applied, and the technology classification number is for determining the technical category. The specific technology may be determined according to the technology classification number and the field keywords. For example, if according to the technology classification number, temperature control technology is determined, and the field keywords are “electronic cigarette”, it will determine that the to-be-evaluated patent case belongs to the temperature control of electronic cigarette.

In one embodiment, the obtaining the applicants and technical fields of the historical patent cases of the attorney by analyzing all the patent case data corresponding to the attorney may include: grabbing classification number and abstract of each patent case in all the patent case data corresponding to the attorney, and extracting technical keywords by analyzing the abstract of the patent case; and determining a technology category corresponding to each patent case in all the patent case data corresponding to the attorney by using rite classification number and the technical keywords as inputs of a technology classification model, and using the determined technology category as a technical field label of the patent case.

In which, the classification number information may be detailed to the level of group, for example, G06K9/00. The abstract refers to the abstract content in a patent document. The abstract is analyzed to extract the technical keywords, and the extraction of the technical keywords may use a semantic-based method, that is, the technical keywords are extracted by performing semantic analysis on the abstract. Then, the technology classification model is used to determine the technology category of the corresponding patent case, and the technology category is stored as the technical label of the patent case, which not only facilitates the applicant to view the technical field of the historical cases of the attorney, but is also convenient for the subsequent matching and recommendations in the technology of patent.

In one embodiment, the technology classification model includes a first feature model, a second feature model, and a classification model. The first feature model is for determining a first feature vector corresponding to the classification number according to the classification number, the second feature model is for determining a second feature vector corresponding to the technical keywords, and the classification model is for determining the technology category corresponding to the patent case based on the first feature vector and the second feature vector.

In which, the first feature model is for converting the classification number into the first feature vector, the second feature model is for converting the technical keywords into the second feature vector and combining the first feature vector and the second feature vector to use as the input of the classification model. The classification mode is for classifying the technology of the patent cases according to the information included in the first feature vector and the second feature vector.

Creating a training set is the most important part of model training. The creation of the traditional training set often requires a lot of manpower and material resources to label the training data. To improve the efficiency of labeling, a method for quickly labeling data is provided. The patent cases corresponding to the technology classification number and technical keywords are searched from the third-party database according to the technology classification number and technical keywords, and the searched patent cases are uniformly marked as the technology category corresponding to the technology classification number and technical keywords. As a result, not only the training data is obtained quickly, but also the fast labeling of the training data is realized.

In one embodiment, the basic information may further include a qualification certificate number of the attorney. The obtaining the basic information of the attorney may include obtaining an official practice experience of the attorney according to the qualification certificate number of the attorney; verifying the basic information of the attorney according to the official practice experience; performing the step of establishing the communicational connection with the third-party database in response to the verification being successful; and returning a result of unsuccessful verification in response to the verification being unsuccessful.

In which, to ensure that the obtained basic information of the attorney is accurate, the obtained information needs to be verified after the basic information is obtained. The verification may include searching the official practice experience of the attorney according to the qualification certificate number of the attorney; and verifying the basic information of the attorney according to the official practice experience. For example, the official practice experience of the attorney may be obtained by interacting with the website of the All-China Agents Association so as to compare with the practice experience filled in the registration information to determine whether the filled information is accurate or not.

In one embodiment, the obtaining the applicants and technical fields of the historical patent cases of the attorney by analyzing all the patent case data corresponding to the attorney may include: extracting applicant information in each patent case in all the patent case data corresponding to the attorney, and counting a number of cases corresponding to each of the applicant information; determining a main applicant according to the number of cases corresponding to each of the applicant information, where the main applicant is an applicant with the largest number of cases; obtaining a technology classification number and technical keywords of each patent case in all the patent case data corresponding to the attorney, and determining the technical field of the patent case according to the technology classification number and technical keywords; and counting a number of cases corresponding to each of the technical fields, and determining a main technical field according to the number of cases corresponding to each of the technical fields.

In which, in order to show the relevant information of the attorney in more detail, the main applicants of the historical cases of the attorney and the main technical fields of the historical cases are counted. The main applicant refers to the main customer of the historical service, and the main technical field refers to the main technical field of the historical service. For example, for the attorney Li San, the mainly served customers include company A, company B, company C, company D, and the like, and the main technical fields include field I, field II, field III, and the like. In this way, it will be convenient for the subsequent customers to have a more accurate understanding of the agent based on the personal introduction information of the attorney so as to choose the most suitable attorney for them.

When there is a large amount of patent attorney information, how to quickly choose a suitable attorney is also a difficult problem for customers. It will undoubtedly be time-consuming and labor-intensive to browse the personal introduction information of each patent attorney one by one. In addition, for non-professionals, the chosen attorney may not be the most suitable. Based on this, a data interaction-based information recommendation method is provided, which can quickly and accurately match patent attorneys and has a wide range of applications.

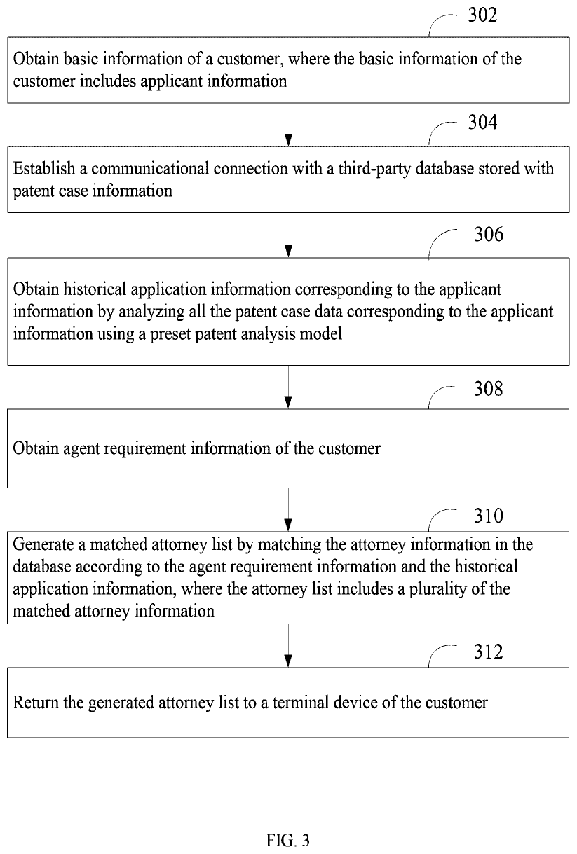

FIG. 3 is a flow chart of a personal introduction information recommending method according to an embodiment of the present disclosure. As shown in FIG. 3, the personal introduction information recommending method applied to the information processing platform is provided. The personal introduction information recommending method may include the following steps.

302: obtaining basic information of a customer, where the basic information of the customer includes applicant information.

In which, the applicant information may be the name and surname of an individual or the name of a company. For a business customer, the applicant information refers to the full name of the business. A customer account may be associated with one or more applicant information. In addition, the basic information of the customer may further include enterprise qualification information, enterprise legal person information, and the like.

304: establishing a communicational connection with a third-party database stored with patent case information.

In which, the third-party database refers to a database that stores the patent case information which may be the patent search database of the China National Intellectual Property Administration, or other patent search databases such as PatSnap, Baiten, and incoPat. For the case submitted by an agency, its patent case information will include the information of the applicant.

306: obtaining historical application information corresponding to the applicant information by analyzing all the patent case data corresponding to the applicant information using a preset patent analysis model.

In which, the patent analysis model is for analyzing all the obtained patent case data to obtain the situation of the historical applications of the applicant. The historical application information may include at least one of the technical fields of the patent case of the historical application, historical cooperation agencies, and historical cooperation attorneys. The technical fields of the patent case may be analyzed through the technology classification number, and then information such as the historical cooperation agencies and attorneys may be extracted from the patent case data. The obtaining of the patent case data of the historical applications of the applicant is conducive to analyzing the actual needs of customers. In another embodiment, the technical fields may be determined through the technology classification number and the technical keywords extracted from the abstract.

308: obtaining agent requirement information of the customer.

In which, the agent requirement information refers to the customer's requirements for the attorney. The agency requirement information may include one or more of field requirement, level requirement, profession requirement, agency requirement, time limit requirement, location requirement, and the like. The field requirement refers to the requirement for the agency profession of the attorney. The agency profession may be divided into four kinds, namely software and communication, electronics, machinery, and biology and chemistry. The level requirement refers to the requirement for the professional level of the attorney. The higher the professional level of the attorney, the better the drafting quality of the attorney, and the corresponding attorney fee will be higher. The profession requirements refer to the requirement for the major that the attorney has studied. For example, for the customers of LED technology, they often require the attorney to understand LED-related knowledge, so the attorney of the optoelectronic technology will be preferred. The agency requirement reflects the customer's trust in an agency. If the customer has cooperated happily with an agency before, the attorney of the agency may be preferred for cooperation. The time limit requirement refers to the time limit for the attorney to return the draft. For example, for a relatively urgent case, the customer will require the draft to be returned in a short time. The location requirements refer to the requirement for the location of the attorney. For example, if some customers want to communicate with the attorney in person, the attorney who is closer to them will be preferred.

310: generating a matched attorney list by matching the attorney information in the database according to the agent requirement information and the historical application information, where the attorney list includes a plurality of the matched attorney information.

In which, the agent requirement information and historical application information are synthesized and then matched with the attorney information in the database to generate the attorney list. The attorneys in the attorney list may be sorted from high to low according to the matching degree, so as to facilitate the subsequent choice of customers. The attorney here refers to a person engaged in patent agency work that is also known as “patent attorney” or “patent agent”.

In one embodiment, the attorneys in the attorney list may also be sorted by multiple dimensions. For example, the dimensions may be divided into a professional dimension (i.e., the highest degree of profession matching), a level dimension (i.e., the highest degree of level matching), and an integrated dimension, (i.e., the dimension ranking that integrate multiple indicators). Customers may sort the dimensions according to the preference. As a result, it will be conducive to providing the customers with more flexible choices.

In one embodiment, it further needs to obtain the historical evaluation information corresponding to the customer, and generate the attorney list by matching with the attorney information in the database according to the agent requirement information, historical application information, and historical evaluation information. In which, the historical evaluation information refers to the evaluation information of the customer on the attorney of the historical case. The historical evaluation information can reflect the customer's recognition of the attorney of the historical case. If the recognition degree is high, the attorney can be recommended later; otherwise, the attorney will not be subsequently recommended later.

312: returning the generated attorney list to a terminal device of the customer.

In which, the attorney list is returned to the terminal device of the customer so that the customer can choose according to the attorney list, which greatly improves the accuracy of choice.

The above-mentioned information recommendation method first obtains customer information (applicant information), establishes the connection with the third-party database, and analyzes all the patent case data corresponding to the applicant to extract the history application information. Then, it is necessary to obtain the agent requirement information of the customer so as to perform attorney information matching according to the historical application information and agent requirement information to generate the matched attorney list and return the generated attorney list to the terminal device of the customer. The personal introduction information recommending method realizes the accurate recommendation of attorneys for customers through various information matching. In addition, the recommendation method is not limited to the recommendation within an agency, but is applicable to the recommendation of all attorneys, and has a wide range of applications.

In one embodiment, the historical application information may include the technical field of the patent case of the historical application and the historical cooperation agencies and attorneys. Before the obtaining the historical application information corresponding to the applicant information by analyzing all the patent case data corresponding to the applicant information using the preset patent analysis model (step 306), the method may further include grabbing all the patent case data corresponding to the applicant from the third-party database according to the applicant information.

In which, the applicant information is used as the search condition for grabbing all the patent case data corresponding to the applicant from the third-party database. As a result, the accuracy of the grabbed patent case data can be ensured.

In one embodiment, the historical application information corresponding to the applicant information is obtained by analyzing all the patent case data corresponding to the applicant information using the preset patent analysis model (step 306) when the historical application information includes the technical field of the patent case of the historical application and the historical cooperation agencies and attorneys may include extracting the technology classification number, technical keywords, agency name and attorney corresponding to each patent case using the preset patent analysis model; determining the technical field corresponding to each patent case according to the technology classification number and the technical keywords; extracting the agency corresponding to each patent case, and counting a number of first cases in the historical cases of each agency to sort the historically cooperative agencies according to the number of first cases; extracting the attorney corresponding to each patent case, and counting a number of second cases in the historical cases of each attorney to sort the historically cooperative attorneys according to the number of second cases.

In which, the patent analysis model is for extracting the technology classification number, technical keywords, agency name and attorney of each patent case. The technical field is for determining the technology to which the customer belongs, for example, electronic cigarettes or smart home. Then agency information is for obtaining the customer's preferred partner agency. The attorney information is for obtaining the customer's preferred partner attorney.

In one embodiment, the agent requirement information may include at least one of field requirement, level requirement, profession requirement, and agency requirement, and the attorney information may include level information, field information, profession information, and belonged agency information.

The generating the matched attorney list by matching with the attorney information in the database according to the agent requirement information, historical application information and historical evaluation information may include: selecting candidate attorneys matching the agent requirement information based on the agent requirement information and the attorney information, calculating a matching degree with respect to each of the candidate attorneys according to the agent requirement information, the historical evaluation information to generate the attorney list according to the matching degree. The attorney information in the attorney list is arranged according to the matching degree.

In which, the fields may be divided according to the actual needs. In one embodiment, the fields may be divided into four kinds, namely software and communication, electronics, machinery, and biology and chemistry. In another embodiment, the field may be further subdivided. For example, the software and communication may be further subdivided into pure software, combination of software and hardware, communication, and so on. The level requirement refers to the requirement for the professional level of the attorney. The attorneys are divided into a plurality of professional levels in advance, where the professional level reflects the professional level of the attorney. The profession requirement refers to the major that the attorney has studied. For example, the majors may be divided into optoelectronic communication, electromechanical automation, and the like. The agency refers to the agency where the attorney is located. The agency requirement may be divided into two types, one is clear requirement, that is, the agency is designated, and the other is vague requirement which only needs to specify the conditions that the agency needs to meet.

In one embodiment, the obtaining agent requirement information of the customer (step 308) may include: obtaining an agent requirement content input by the customer, extracting semantic information of the agent requirement content by performing semantic analysts on the agent requirement content; and determining the agent requirement information of the customer based on the semantic information. The agent requirement information may include at least one of field requirement, professional level requirement, profession requirement, and time limit requirement.

In which, the agent requirement content is the content input by the customer according to the actual needs. The input method may be voice input or manual input. For example, the customer input “I need an attorney of electrical technology and request to return the draft within 15 days” in voice. Through performing semantic analysis on the input content, the extracted agent requirement information of the customer will be: electrical field technology, and 15-day time limit.

In one embodiment, the extracting the semantic information of the agent requirement content by performing semantic analysis on the agent requirement content may include: taking the agent requirement content as an input of a semantic analysis model, and extracting the semantic information of the agent requirement content using the semantic analysts model. The semantic information may include semantic relationship and semantic content.

In which, the semantic information is often used to represent intention information of the intention of the user. In one embodiment, the intent information may be represented in the form of a triplet, a combination of triples, an intent triplet, or a combination of intent triples. In one embodiment, the semantic information may include triples or a combination of triples. The triple refers to structural data in the form of (x, y, z) to identify x, y, z and the corresponding relationship. In one embodiment, the triple consists of a syntactic/semantic relationship and two concepts, entities, words or phrases. The intent triple is a user intent stored in the form of a triple, which is a small unit to identify a complete intent and can be identified as (subject, relation, object), where “subject” represents the first entity, and “relation” represents the relationship between “subject” and “object”, “object” represents the second entity. For example, “I need the attorney of electrical technology” can be represented in the triple as (i, need, attorney of electrical technology).

The training of the semantic analysis model often requires to create of a large amount of data. Since the application scenario of the semantic analysis model in this scheme is relatively special, the creation of the training data of the semantic analysis model has its particularity. Based on the particularity of the application scenario, a method to quickly create the training datasets for the semantic analysis model is provided. The method may include:

determining the candidate keywords for field requirement, the candidate keywords for professional level requirement, the candidate keywords for profession requirement, and the candidate keywords for time limit requirement;

automatically generating a training sentence including the candidate keywords of the field requirement according to the candidate keywords of the field requirement using a preset template, and using the candidate keywords of the corresponding field requirements as a semantic annotation of the training sentence;

automatically generating a training sentence including the candidate keywords of the professional level requirement according to the candidate keywords of the professional level requirement using the preset template, and using the corresponding candidate keywords as the semantic annotation of the training sentence;

automatically generating a training sentence including the candidate keywords of the profession requirement according to the candidate keywords of the profession requirement using the preset template, and using the corresponding candidate keywords as the semantic annotation of the training sentence; and

generating a training sentence including the candidate keywords of the time limit requirement according to the candidate keywords of the time limit requirement using the preset template, and using the corresponding candidate keywords as the semantic annotation of the training sentence.

Through the above-mentioned method, the purpose of quickly creating a training data set can be achieved, which is conducive to improving the speed of model training while greatly reducing the cost.

In one embodiment, the attorney information may include professional level information, field information, profession information, and time information. The generating the matched attorney list by matching with the attorney information in the database according to the agent requirement information, historical application information and historical evaluation information may include selecting the candidate attorneys matching the agent requirement information from the attorney information based on the agent requirement information; calculating a matching degree with respect to each candidate attorney according to the agent requirement information, the historical evaluation information, and the historical application information, and generating the attorney list according to the matching degree. The attorney information in the attorney list is arranged according to the matching degree.

In which, the information included in the agent requirement information is the relatively accurate requirement information, so the attorney that matches the agent requirement information may be selected as the candidate attorneys based on the agent requirement information first. For example, if the agent requirement information includes the professional level of the attorney, the attorneys that meet the professional level may be directly selected as the candidate attorneys, which is beneficial to reduce the computational workload for subsequent matching. After the candidate attorneys are obtained, further matching is required. The synthesized matching degree is calculated according to the agent requirement information, the historical evaluation information, and the historical application information to obtain the matching degree with respect to each candidate attorney. The arrangement according to the degree of matching is beneficial to the customer to choose the attorney with high matching degree first. In the above-mentioned process, the candidate attorneys are selected based on the agent requirement information first, and then the matching degree with respect to each candidate attorney is calculated, which is conducive to reducing the workload of the matching calculation and greatly improving the matching efficiency.

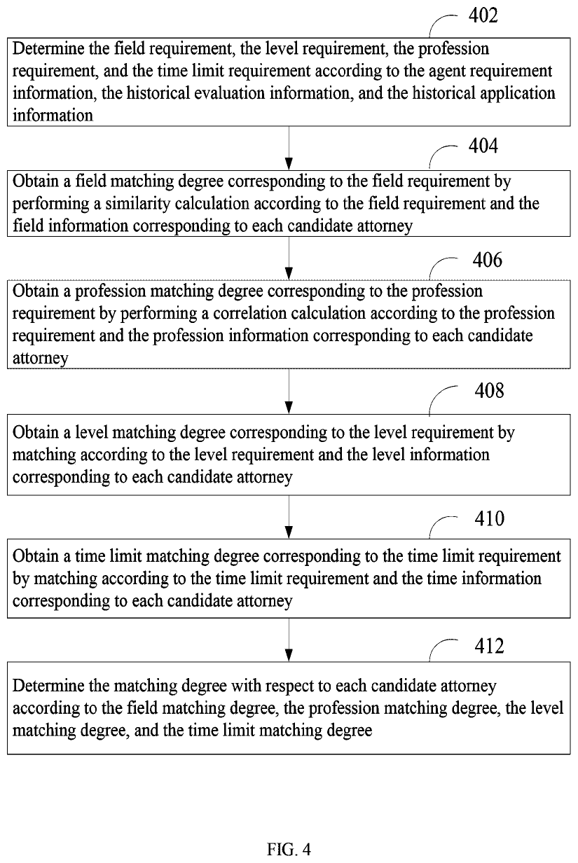

FIG. 4 is a flow chart of a method for calculating a degree of matching with each candidate attorney according to an embodiment of the present disclosure. As shown in FIG. 4, in one embodiment, the calculating the matching degree with respect to each candidate attorney according to the agent requirement information, the historical evaluation information, and the historical application information may include the following steps.

402: determining the field requirement, the level requirement, the profession requirement, and the time limit requirement according to the agent requirement information, the historical evaluation information, and the historical application information.

In which, if the information of requirements included in the agent requirement information is relatively comprehensive, for example, including the field requirement, the agency requirement, and the profession requirement simultaneously, the information can be determined according to the agent requirement information. Otherwise, if the agent requirement information does not include so much information, it is necessary to analyze the missing information according to the historical application information and the historical evaluation information. For example, if there is no profession requirement in the agent requirement information, then the customer's profession requirement information may be analyzed according to the technical fields in the historical application information.

The level requirement may be null, that is, the user may not limit the level. Similarly, the profession requirement may also be null, and the time limit requirement may also be null, that is, the user may not limit the profession and time. However, the field requirement cannot be null because the attorneys of different fields ate suitable for different kinds of cases. Therefore, in order to match the fields suitable for the case of the customer, the field requirement cannot be null.

404: obtaining a field matching degree corresponding to the field requirement by performing a similarity calculation according to the field requirement and the field information corresponding to each candidate attorney.

In which, the field matching degree may be calculated using the method of field similarity. In one embodiment, the field matching degree may be calculated using the following equation. First, the field requirement may be expressed in the form of a vector. Similarly, the field information of the attorney may be also represented as a vector.

$$D = \frac{\text{?} {x}_{i} {y}_{i}}{\sqrt{\text{?} {x}_{i}^{2}} \sqrt{\text{?}}} ;$$

$$\text{?} \text{indicates text missing or illegible when filed}$$

In which, D represents the field similarity, xᵢ represents the i-th eigenvalue in a field requirement vector, and yᵢ represents the i-th eigenvalue in a field information vector.

406: obtaining a profession matching degree corresponding to the profession requirement by performing a correlation calculation according to the profession requirement and the profession information corresponding to each candidate attorney.

In which, the profession matching degree may be calculated using the method of profession similarity. In one embodiment, the profession matching degree may be calculated using the following equation:

d=\sqrt{Σᵢ₌₁^{x}(xᵢ−yᵢ)²};

where, d represents the profession similarity, xᵢ represents the i-th eigenvalue in a profession requirement vector, and yᵢ represents the i-th eigenvalue in a profession information vector.

408: obtaining a level matching degree corresponding to the level requirement by matching according to the level requirement and the level information corresponding to each candidate attorney.

In which, the matching rules between levels may be set in advance. For example, the matching degree of the same levels may be 100%, and the matching of the level may take the higher ones rather than taking the lower ones by, as an example, if the customer requires the level to be level two, the matching degree between level two and a level lower than level two may be set to 0. In addition, the matching degree higher than level two may be gradually reduced. For example, the matching degree between level three and level two is 80%, the matching degree between level four and level two is 60%, and so on.

410: obtaining a time limit matching degree corresponding to the time limit requirement by matching according to the lime limit requirement and the time information corresponding to each candidate attorney.

In which, the rules of the matching degree between time limits may be set according to actual needs, and the matching of the level may take the lower ones rather than taking the higher ones by, as an example, if the customer requires the time limit of 10 days for returning the draft, the time information may be returning the draft in less than 10 days, and the corresponding matching degree will be set to 0 when exceeding 10 days.

412: determining the matching degree with respect to each candidate attorney according to the field matching degree, the profession matching degree, the level matching degree, and the time limit matching degree.

In which, after the field matching degree, the profession matching degree, the level matching degree and the time limit matching degree are known, a synthesized matching degree may be obtained by synthesizing a plurality of matching degrees, and the synthesized matching degree may be used as the matching degree with respect to the candidate attorneys. By synthesizing multiple factors for matching, it will be conducive to providing the customers with more suitable attorneys.

In one embodiment, the determining the matching degree with respect to each of the candidate attorneys according to the field matching degree, the profession matching degree, the level matching degree, and the time limit matching degree may include: obtaining preference information of the customer from the agent requirement information and the historical evaluation information, where the reference information includes the customer's preference for the field requirement, the profession requirement, the level demand, and time limit requirement; using the preference information as an input of the weight analysis model to obtain a field weight corresponding to the field matching degree, a profession weight corresponding to the profession matching degree, a level weight corresponding to the level requirement and a time limit weight corresponding to the time limit requirement that are output by the weight analysis model; and calculating the matching degree with respect to each of the candidate attorneys according to the field matching degree, the field weight, the profession matching degree, the profession weight, the level requirement, the level weight, the time limit requirement, and the time limit weight.

In which, because different customers have different preference for each factor, in order to match a more suitable attorney, it is necessary to determine the weight of each factor using the weight analysis model according to the customer's preference information. Then, the matching degree with respect to each candidate attorney is calculated by means of weighted summation.

In order to quickly recommend the matched patent attorneys for customers, an attorney information database and a customer information database may be created on the information processing platform in advance. In this way, when a customer needs a recommendation for attorneys, the historical application information may be obtained from the customer information database after obtaining attorney requirement information.

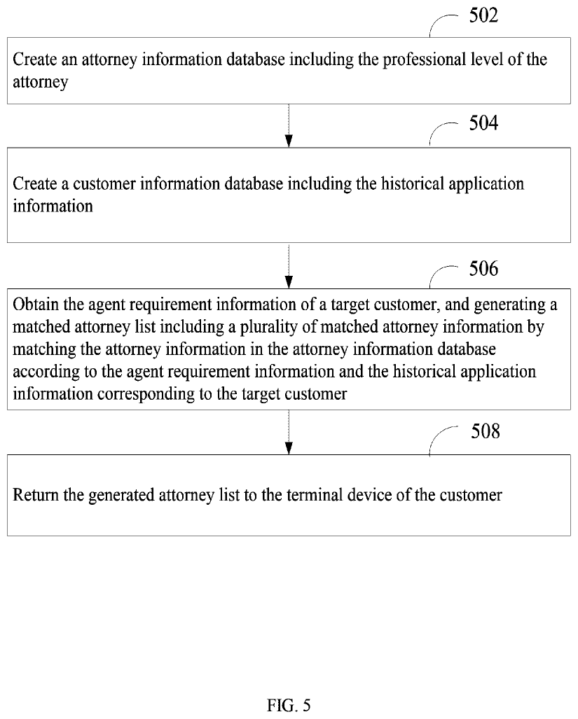

FIG. 5 is a flow chart of an information interaction method according to an embodiment of the present disclosure. As shown in FIG. 5, in one embodiment, an information interaction method for the information processing platform is provided. The information interaction method may include the following steps.

502: creating an attorney information database including the professional level of the attorney.

In which, the attorney information database stores the personal introduction information of the attorney including the professional level of the attorney. In addition, the personal introduction information of the attorney may further include the main applicant of the historical cases and the main technical field of the historical cases. The personal introduction information of the attorney is obtained through the above-mentioned personal introduction information generating method.

504: creating a customer information database including the historical application information.

In which, a lot of customer information each including the historical application information is stored in the customer information database. The historical application information refers to the information obtained by analyzing patent document data of the historical applications of the customer, which includes at least one of the technical field of the patent cases of the historical applications, the historical cooperation agencies, and the historical cooperation attorneys.

In one embodiment, the customer information database may further include the historical evaluation information. The historical evaluation information refers to the customer's evaluation of the historical cooperation attorney, which may include profession evaluation, service attitude evaluation, and the like.

The generating the matched attorney list by matching with the attorney information in the database according to the agent requirement information, the historical application information and historical evaluation information may include:

generating the matched attorney list by matching with the attorney information in the attorney information database according to the agent requirement information and the historical application information and historical evaluation information corresponding to the customer. That is, the attorney list is obtained by matching with the attorney information according to the agent requirement information, the historical application information, and the historical evaluation information at the same time.

506: obtaining the agent requirement information of a target customer, and generating a matched attorney list including a plurality of matched attorney information by matching the attorney information in the attorney information database according to the agent requirement information and the historical application information corresponding to the target customer.

In which, the agency requirement information refers to the more accurate requirement information input by the customer, which includes one or more of the professional level requirement for the attorney, the profession requirement for the attorneys the practice duration requirement in years for the attorney, the time limit for the completion of the case, and the like. The agent requirement information and the historical application information are synthesized to match with the attorney information in the database so as to generate the attorney list. The attorneys in the attorney list may be sorted from high to low according to the matching degree, so as to facilitate the subsequent choice of customers.

In another embodiment, the method may further include: obtaining the historical evaluation information of the target customer; and generating the matched attorney list by matching with the attorney information in the attorney information database according to the agent requirement information and the historical application information and historical evaluation information corresponding to the target customer.

508: returning the generated attorney list to the terminal device of the customer.

In which, the attorney list is returned to the terminal device of the customer, and the customer chooses according to the attorney list, which greatly improves the choice accuracy.

In the above-mentioned information interaction method, the attorney information database and the customer information database are created on the information processing platform in advance, so that when the customer needs a recommendation for attorneys, the historical application information and the historical evaluation in formation can be directly obtained from the customer information database after obtaining the attorney requirement information, and the matched attorney list is obtained by matching with the attorney information in the attorney information database based on the agent requirement information, historical application information and historical evaluation information of three aspects, and then the attorney list is returned to the terminal device of the customer as the recommendation result. In the information interaction method, since the attorney information database and the customer information database are created in advance, the matched patent attorneys can be quickly and accurately recommended for the customer.

In one embodiment, the above-mentioned information interaction method may further include receiving an intended attorney selected from the attorney list that is sent by the terminal device of the customer, and sending an intention request of the customer to a terminal device of the intended attorney; receiving an intention result sent by the terminal device of the intended attorney; if the intention result is agree, establish an instant communication connection channel between the terminal device of the customer and that of the attorney, where the instant communication connection channel is for performing case communications between the customer and the attorney; and storing the case communication process between the customer and the attorney as a case communication process document, where the case communication process document is stored in association with the corresponding patent case.

In which, after the attorney list is pushed to the terminal device of the customer, the customer chooses the intended attorney from the attorney list. Due to the two-way choices on the information processing platform, it is also necessary to send the intention request to the terminal device of the intended attorney for confirmation. Only after the intended attorney agrees to the entrustment, the instant communication connection channel between the terminal device of the customer and that of the attorney can be established. The customer and the attorney can communicate for the cases through the instant communication connection channel, and the communication process document is stored, which is convenient for the subsequent reviewing where there is a disagreement, and also facilitates the attorney to repeatedly review the communication process document to understand the technical scheme. By storing the case communication process documents in association with the corresponding patent documents, it is also convenient to check the communication records corresponding to the case in the future, without the need to search from a large amount of information.

At present, the information of all instant messaging tools is stored uniformly. When a certain time point or event needs to be viewed, it is necessary to search from numerous historical chat records, which is inefficient. In this method, the case communication process document is stored in association with the corresponding patent case in an innovative manner, so that the communication process of each case can be quickly viewed in the future.

In one embodiment, the above-mentioned information interaction method may further include encrypting and storing the case communication process document to ensure the security of the information of the customer.

In one embodiment, the above-mentioned information interaction method may further include creating a customer case information database. The creating the customer case information database may include grabbing published patent case information corresponding to customer information from the third-party database by interacting with the third-party database, where the published patent case information includes a case examination status; obtaining pending patent case information corresponding to the customer, where the pending patent case information includes a case processing status; and storing the published patent case information and pending patent case information corresponding to a same customer in the customer case information database corresponding to the same customer, where one customer corresponds to one customer case information database.

In which, in order to facilitate customers to manage and view their own cases, a customer case information database is created for each customer on the information processing platform, and the published patent case data of the customer is grabbed from the third-party database to store in the customer case information database. In addition, the pending patent case information corresponding to the customer is added to the customer case information database, so that customers can quickly check the status of all cases by logging into the information processing platform. In this way, the customers can directly manage cases through the information processing platform, so that customers can more quickly and accurately know the status of each case. Compared with the existing method that the status of the case can only find out by inquiring to the agency, this method is undoubtedly faster and more accurate.

In one embodiment, the above-mentioned method may further include receiving a case viewing request sent by the terminal device of the customer; and obtaining patent case information corresponding to authority information from the customer case information database to return to the terminal device of the customer for display, in response to a request for obtaining the authority information corresponding to the customer.

In which, after the terminal device of the customer logs in to the information processing platform, there are many ways to send the case viewing request and trigger the case viewing request, for example, directly clicking a case query button.

Different customers have different permissions. Some customers have permissions to view all the case information, while other customers can only view their own corresponding cases. For example, for the same company, the users may be divided into managers and ordinary employees. The manager's authority can be allowed to view the cases of all ordinary employees, while ordinary employees can only be allowed to view their corresponding cases. The setting of permissions is beneficial to the confidentiality of information. In the above-mentioned process, after obtaining the case viewing request, the authority corresponding to the customer is determined first, and then the patent case information corresponding to the authority information is returned to the terminal device of the customer for display. This method greatly improves the flexibility of case inquiry, and it is beneficial to information security by setting the authority information in the inquiry process.

In one embodiment, the published patent case information may further include patent examination process documents including one or more of acceptance notice, correction notice, examination opinion notice, and examination response document. The pending patent case information may include patent processing process documents including one or more of technical disclosure document, case communication process document, and case draft.

In which, the above-mentioned published patent case information may further include process document generated during patent examination. The process documents may include one or more of acceptance notice, correction notice, examination opinion notice and examination response document. The information processing platform may directly receive the official examination process documents (i.e., the acceptance notice, the correction notice, and the examination opinion notice), and then the received examination process documents may be stored in association with the corresponding case. In this way, customers can query and obtain all relevant documents on the information processing platform, which is convenient and quick.

In one embodiment, the creating the attorney information database may include obtaining the basic information of the attorney including the name and surname of the attorney and the practice experience, where the practice experience includes the name of the agency corresponding to the practice period of the attorney; establishing the communicational connection with the third-party database, where the third-party database is stored with the patent case information including the name of the agency and the name and surname of the attorney; extracting all the patent cases corresponding to the attorney from the third-party database according to the name and surname of the attorney and the practice experience; counting the historical approval rate of the attorney by processing all the patent case data corresponding to the attorney using the built patent case data processing model; extracting the preset number of to-be-evaluated patent cases within the preset period in years from all the patent case data corresponding to the attorney; determining the technical field to which the to-be-evaluated patent cases belongs by performing technical analysis on the to-be-evaluated patent cases; sending the to-be-evaluated patent cases to the expert corresponding to the technical field for review according to the technical field to receive the returned review result; obtaining the historical service evaluation information corresponding to the attorney; determining the professional level of the attorney according to the historical approval rate of the attorney, the review result and the historical service evaluation information using the preset algorithm; obtaining the main applicant of the historical cases of the attorney and the main technical field of the historical cases; generating the personal introduction information corresponding to the attorney according to the professional level of the attorney, the main applicant of the historical cases, and the main technical field of the historical cases using the preset template; and storing the personal introduction information corresponding to the attorney in the attorney information database.

In one embodiment, the establishing the customer information database may include obtaining the basic information of the customer, where the basic information includes the applicant information; establishing the connection with the third-party database storing the patent case information; grabbing all the patent case data corresponding to applicant information from the third-party database; obtaining the historical application information corresponding to the applicant information by using the preset patent analysis model to analyze all the patent case data corresponding to applicant information, when the historical application information may include the technical fields of the patent cases of the historical applications, the historical cooperation agencies, and the historical cooperation attorneys; and storing the historical application information corresponding to the customer in the customer information database.

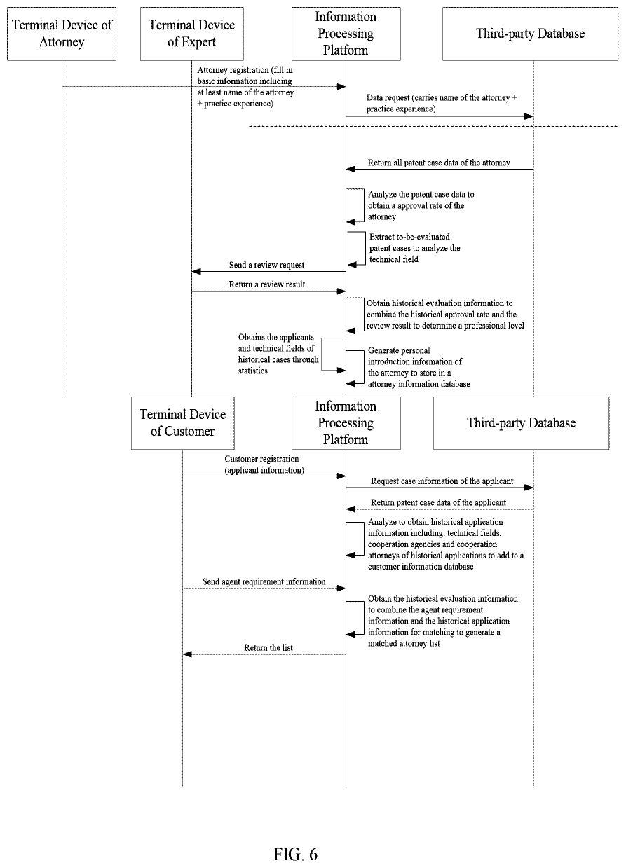

FIG. 6 is a timing diagram of the process of information exchange according to an embodiment of the present disclosure. As shown in FIG. 6, a timing diagram of the information exchange consists of two parts. The first part is the liming diagram of generating the personal introduction information of the attorney, and the second part is the timing diagram of recommending the attorney.

The first part: first, the attorney registers through the terminal device of the attorney. During the registration, the basic information of the attorney needs to be filled in. The basic information of the attorney includes the name and surname of the attorney and the practice experience. After receiving the basic information of the attorney, the information processing platform sends a data request (which carries the name and surname of the attorney+the practice experience) to the third-party database, and receives the patent case data returned by the third-party database. Then the information processing platform analyzes the patent case data to count the historical approval rate. In addition, the information processing platform further extracts a preset number of to-be-evaluated patent cases within a preset period in years from the patent case data to conduct technical analysis so as to determine the technical field to which the to-be-evaluated patent cases belongs. After that, the to-be-evaluated patent case is sent to the corresponding experts for review, and the returned review result is received. Furthermore, the information processing platform obtains the historical service evaluation information corresponding to the attorney from its own database, then the professional level of the attorney is determined according to the historical approval rate of the attorney, the review result, and the historical service evaluation information. Still furthermore, the information processing platform obtains the main applicants of the historical case and the main technical fields of the historical case are through counting by analyzing all the patent case data corresponding to the attorney. Finally, the personal introduction information corresponding to the attorney is generated according to the professional level of the attorney, the main applicants of the historical case, and the main technical fields of the historical case using a preset template, and the generated personal introduction information is stored in the attorney information database.

The second part: the customer registers on the information processing platform through the terminal device of the customer, and fills in the customer's basic information (at least includes the applicant information) during registration. The information processing platform grabs the corresponding patent case data from the third-party database according to the applicant information, and uses a preset patent analysis model to analyze all the patent case data corresponding to the applicant information to obtain the historical application information corresponding to the applicant information to add to the customer information database, where the historical application information includes the technical fields of the patent cases of the historical applications, the historical cooperation agencies and attorneys. In addition, the information processing platform further obtains the agent requirement information sent by the terminal device of the customer, and obtains the historical evaluation information corresponding to the customer from its own database, and finally matches with the attorney information in the database according to the agent requirement information, the historical evaluation information, and the historical application information to generate the matched attorney list including multiple matched attorney information so as to return the generated attorney list to the terminal device of the customer. The terminal device of the customer selects the intended attorney for the information processing platform to send to the terminal device of the attorney for confirmation. After the attorney agrees, an agreement is reached.

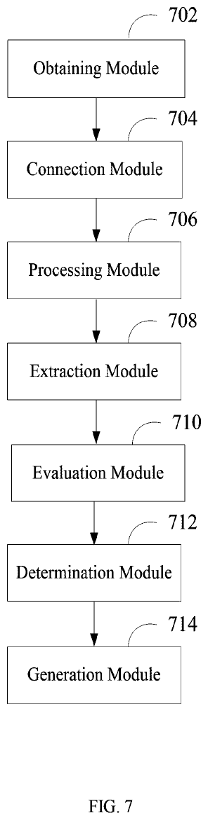

FIG. 7 is a schematic block diagram of the structure of a personal introduction information generating apparatus according to an embodiment of the present disclosure. As shown in FIG. 7, personal introduction information generating apparatus is provided. The personal introduction information generating apparatus may include:

an obtaining module 702 configured to obtain basic information of an attorney, wherein the basic information includes identification information of the attorney;

a connection module 704 configured to establish a communicational connection with a third-party database stored with patent case information including the identification information of the attorney;

a processing module 706 configured to calculate a historical approval rate related to the attorney within a preset time by processing all patent case data corresponding to the attorney using a preset patent case data processing model;

an extraction module 708 configured to extract a preset number of to-be-evaluated patent cases within a preset period in years from all the patent case data corresponding to the attorney;

an evaluation module 710 configured to send the to-be-evaluated patent cases to a corresponding expert for review to receive a review result returned by the expert; and

a determination module 712 configured to determine a professional level of the attorney using a preset algorithm according to the historical approval rate of the attorney and the review result; and

a generation module 714 configured to generate the personal introduction information corresponding to the attorney using a preset template according to the professional level of the attorney.

In one embodiment, the above-mentioned apparatus may further include an extraction module configured to extract all the patent case data corresponding to the attorney from the third-party database according to the name and surname of the attorney and the practice experience of the attorney.

In one embodiment, the basic information may further include agency profession; and the extraction module 708 may be further configured to select candidate patent case data matching the agency profession from all the patent case data corresponding to the attorney; and extract the to-be-evaluated patent cases within the preset period in years from the candidate patent case data.

In one embodiment, the processing module 706 may be further configured to extract a legal status of each of patent cases in all the patent case data corresponding to the attorney using the preset patent case data processing model, where the legal status includes one of approved, examining, denied, and withdrawn, and the patent case data processing model is for determining a regular expression corresponding to the legal status and extracting the legal status of the patent case based on the regular expression; count a number of the patent cases with the legal status of approved, a number of the patent cases with the legal status of denied, and a number of the patent cases with the legal status of withdrawn; and calculate the historical approval rate according to the number of the patent cases, the number of the patent cases, and the number of the patent cases.

In one embodiment, the processing module 706 may be further configured to count the number of the patent cases, the number of the patent cases and the number of the patent cases in a preset number of closed cases closest to a current time; and calculate a latest historical approval rate according to the number of the patent cases, the number of the patent cases and the number of the patent cases in the preset number of closed cases closest to the current time.

In one embodiment, the processing module 706 may be further configured to select candidate patent cases each having a filing date within a preset time period from the patent cases in all the patent case data; and count the number of the patent cases with the legal status of approved, the number of the patent cases with the legal status of denied, and the number of the patent cases with the legal status of withdrawn in the candidate patent cases; calculate the historical approval rate corresponding to the preset time period according to the number of the patent cases with the legal status of approved, the number of the patent cases with the legal status of denied, and the number of the patent cases with the legal status of withdrawn in the candidate patent cases.

In one embodiment, the determination module 712 may be further configured to obtain practice duration in years of the attorney and a total number of historical applications of the attorney, and using the practice duration in years and the total number of historical applications as inputs to a weight determination model, where the weight determination model is trained based on a deep neural network model; obtain a first weight corresponding to the historical approval rate of the attorney, a second weight corresponding to the review result and a third weight corresponding to the historical service evaluation information output by the weight determination model; and determine the professional level of the attorney according to the historical approval rate and the first weight, the review result and the second weight, and the historical service evaluation information and the third weight.

In one embodiment, the extraction module 708 may be further configured to determine target search conditions according to the name and surname of the attorney and the practice experience of the attorney, where the target search conditions include the name and surname of the attorney and the one or more agency names and the corresponding practice period; and extract all the patent case data corresponding to the attorney from the third-party database according to the target search conditions.

In one embodiment, the above-mentioned apparatus may further include an analysis module configured to obtain applicants and technical fields of historical patent cases of the attorney by analyzing all the patent case data corresponding to the attorney.

The analysis module may be further used to grab classification number and abstract of each patent case in all the patent case data corresponding to the attorney, and extract technical keywords by analyzing the abstract of the patent case; and determine a technology category corresponding to each of the historical patent cases of the attorney by using the classification number and the technical keywords as inputs of a technology classification model, and use the determined technology category as a technical field label of the patent case.

In one embodiment, the technology classification model may include a first feature model, a second feature model, and a classification model. The first feature model is for determining a first feature vector corresponding to the classification number according to the classification number, the second feature model is for determining a second feature vector corresponding to the technical keywords, and the classification model is for determining the technology category corresponding to the patent case based on the first feature vector and the second feature vector.

In one embodiment, the basic information may further include a qualification certificate number of the attorney; and the above-mentioned apparatus may further include a verification module configured to obtain an official practice experience of the attorney according to the qualification certificate number of the attorney; verify the basic information of the attorney according to the official practice experience; notify the connection module to establishing the communicational connection with the third-party database in response to the verification being successful; and return a result of unsuccessful verification in response to the verification being unsuccessful.

In one embodiment, the apparatus may further includes a counting module configured to extract applicant information in each of the historical patent cases of the attorney, and count a number of cases corresponding to each of the applicant information; determine a main applicant according to the number of cases corresponding to each of the applicant information, where the main applicant is an applicant with the largest number of cases; obtain a technology classification number and technical keywords of each of the historical patent cases of the attorney, and determine the technical field of the patent case according to the technology classification number and technical keywords; and count a number of cases corresponding to each of the technical fields, and determine a main technical field according to the number of cases corresponding to each of the technical fields.

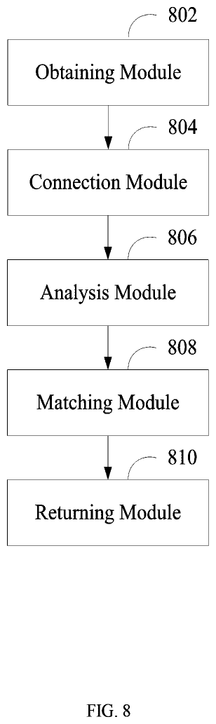

FIG. 8 is a schematic block diagram of the structure of a personal introduction information recommending apparatus according to an embodiment of the present disclosure. As shown in FIG. 8, an personal introduction information recommending apparatus is provided. The apparatus may include:

an obtaining module 802 configured to obtain basic information of a customer, where the basic information of the customer includes applicant information;

a connection module 804 configured to establish a communicational connection with a third-party database stored with patent case information;

an analysis module 806 configured to obtain historical application information corresponding to the applicant information by analyzing all the patent case data corresponding to the applicant information using a preset patent analysts model, where the historical application information may include the technical fields of the patent cases of the historical applications, the historical cooperation agencies, and the historical cooperation attorneys;

where the obtaining module 802 may be further configured to obtain agent requirement information of the customer;

a matching module 808 configured to generate a matched attorney list by matching the attorney information in the database according to the agent requirement information and the historical application information, where the attorney list includes a plurality of the matched attorney information; and

a returning module 810 configured to return the generated attorney list to a terminal device of the customer.

In one embodiment, the above-mentioned apparatus may further include a grabbing module configured to grab all the patent case data corresponding to the applicant from the third-party database according to the applicant information.

In one embodiment, the analysis module 806 may be further configured to extract the technology classification number, technical keywords, agency name and attorney corresponding to each patent case using the preset patent analysis model; determine the technical field corresponding to each patent case according to the technology classification number and the technical keywords; extract the agency corresponding to each patent case, and count a number of first cases in the historical cases of each agency to sort the historically cooperative agencies according to the number of first cases; extract the attorney corresponding to each patent case, and count a number of second cases in the historical cases of each attorney to sort the historically cooperative attorneys according to the number of second cases.

In one embodiment, the obtaining module 802 may be further configured to obtain an agent requirement content input by the customer; extract semantic information of the agent requirement content by performing semantic analysis on the agent requirement content; and determine the agent requirement information of the customer based on the semantic information. The agent requirement information may include at least one of field requirement, professional level requirement, profession requirement, and time limit requirement.

In one embodiment, the attorney information may include professional level information, field information, profession information, and time information. The matching module 808 may be further configured to select the candidate attorneys matching the agent requirement information from the attorney information based on the agent requirement information; calculate a matching degree with respect to each candidate attorney according to the agent requirement information, the historical evaluation information, and the historical application information; and generate the attorney list according to the matching degree. The attorney information in the attorney list is arranged according to the matching degree.

In one embodiment, the matching module 808 may be further configured to determine the field requirement, the level requirement, the profession requirement, and the time limit requirement according to the agent requirement information, the historical evaluation information, and the historical application information; obtain a field matching degree corresponding to the field requirement by performing a similarity calculation according to the field requirement and the field information corresponding to each candidate attorney; obtain a profession matching degree corresponding to the profession requirement by performing a correlation calculation according to the profession requirement and the profession information corresponding to each candidate attorney; obtain a level matching degree corresponding to the level requirement by matching according to the level requirement and the level information corresponding to each candidate attorney; obtain a time limit matching degree corresponding to the time limit requirement by matching according to the time limit requirement and the time information corresponding to each candidate attorney; and determine the matching degree with respect to each candidate attorney according to the field matching degree, the profession matching degree, the level matching degree, and the time limit matching degree.

In one embodiment, the matching module 808 may be further configured to obtain preference information of the customer from the agent requirement information and the historical evaluation information, where the reference information includes the customer's preference for the field requirement, the profession requirement, the level demand, and time limit requirement; use the preference information as an input of the weight analysis model to obtain a field weight corresponding to the field matching degree, a profession weight corresponding to the profession matching degree, a level weight corresponding to the level requirement and a time limit weight corresponding to the time limit requirement that are output by the weight analysis model; and calculate the matching degree with respect to each of the candidate attorneys according to the field matching degree, the field weight, the profession matching degree, the profession weight, the level requirement, the level weight, the time limit requirement, and the time limit weight.

In one embodiment, the attorney information may include level information. The level information may be determined by obtaining the basic information of the attorney. The basic information of the attorney includes the name and surname of the attorney and the practice experience, where the practice experience includes the name of the agency corresponding to the practice period of the attorney; establishing the communicational connection with the third-party database, where the third-party database is stored with the patent case information including the name of the agency and the name and surname of the attorney; extracting all the patent cases corresponding to the attorney from the third-party database according to the name and surname of the attorney and the practice experience; counting the historical approval rate of the attorney by processing all the patent case data corresponding to the attorney using the built patent case data processing model; extracting the preset number of to-be-evaluated patent cases within the preset period in years from all the patent case data corresponding to the attorney; determining the technical field to which the to-be-evaluated patent cases belongs by performing technical analysis on the to-be-evaluated patent cases; sending the to-be-evaluated patent cases to the expert corresponding to the technical field for review according to the technical field to receive the returned review result; obtaining the historical service evaluation information corresponding to the attorney; determining the professional level of the attorney according to the historical approval rate of the attorney, the review result and the historical service evaluation information using the preset algorithm.

In one embodiment, the above-mentioned an personal introduction information recommending apparatus may further includes a communication establishing module configured to receive an intended attorney selected from the attorney list that is sent by the terminal device of the customer, and send an intention request of the customer to a terminal device of the intended attorney; receive an intention result sent by the terminal device of the intended attorney; if the intention result is agree, establish an instant communication connection channel between the terminal device of the customer and that of the attorney, where the instant communication connection channel is for performing case communications between the customer and the attorney.

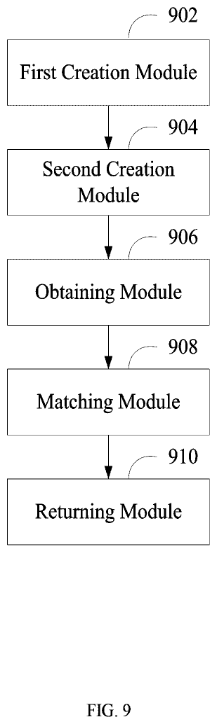

FIG. 9 is a schematic block diagram of the structure of an information interaction apparatus according to an embodiment of the present disclosure. As shown in FIG. 9, the information interaction apparatus is provided. The information interaction device may include:

a first creation module 902 configured to create an attorney information database including a plurality of attorney information each including a professional level of an attorney;

a second creation module 904 configured to create a customer information database including a plurality of customer information each including historical application information;

an obtaining module 906 configured to obtain agent requirement information of a target customer;

a matching module 908 configured to generate a matched attorney list by matching with the attorney information in the attorney information database according to the agent requirement information and the historical application information corresponding to the target customer; and

a returning module 910 configured to return the generated attorney list to a terminal device of the customer.

In one embodiment, the above-mentioned information interaction apparatus may further include:

a receiving module configured to receive an intended attorney selected from the attorney list that is sent by the terminal device of the customer, and send an intention request of the customer to a terminal device of the intended attorney; receive an intention result sent by the terminal device of the intended attorney;

a communication establishing module configured to, if the intention result is agree, establish an instant communication connection channel between the terminal device of the customer and that of the attorney, where the instant communication connection channel is for performing case communications between the customer and the attorney; and

a storage module configured to store the case communication process between the customer and the attorney as a case communication process document, where the case communication process document is stored in association with the corresponding patent case.

In one embodiment, the first creation module 902 may be further configured to grab published patent case information corresponding to customer information from the third-party database by interacting with the third-party database, where the published patent case information includes a case examination status; obtain pending patent case information corresponding to the customer, where the pending patent case information includes a case processing status; and store the published patent case information and pending patent case information corresponding to a same customer in the customer case information database corresponding to the same customer, where one customer corresponds to one customer case information database.

In one embodiment, the above-mentioned information interaction apparatus may further include:

a search module configured to receive a case viewing request sent by the terminal device of the customer; and obtain patent case information corresponding to authority information from the customer case information database to return to the terminal device of the customer for display, in response to a request for obtaining the authority information corresponding to the customer.

In one embodiment, the published patent case information may further include patent examination process documents including one or more of acceptance notice, correction notice, examination opinion notice, and examination response document. The pending patent case information may include patent processing process documents including one or more of technical disclosure document, case communication process document, and case draft.

In one embodiment, the second creation module 904 may be further configured to obtain the basic information of the attorney including the name and surname of the attorney and the practice experience, where the practice experience includes the name of the agency corresponding to the practice period of the attorney; establish the communicational connection with the third-party database, where the third-party database is stored with the parent case information including the name of the agency and the name and surname of the attorney; extract all the patent cases corresponding to the attorney from the third-party database according to the name and surname of the attorney and the practice experience; count the historical approval rate of the attorney by processing all the patent case data corresponding to the attorney using the built patent case data processing model; extract the preset number of to-be-evaluated patent cases within the preset period in years from all the patent case data corresponding to the attorney; determine the technical field to which the to-be-evaluated patent cases belongs by performing technical analysis on the to-be-evaluated patent cases; sending the to-be-evaluated patent cases to the expert corresponding to the technical field for review according to the technical field to receive the returned review result; obtain the historical service evaluation information corresponding to the attorney, determine the professional level of the attorney according to the historical approval rate of the attorney, the review result and the historical service evaluation information using the preset algorithm; obtain the main applicant of the historical cases of the attorney and the main technical field of the historical cases; generating the personal introduction information corresponding to the attorney according to the professional level of the attorney, the mam applicant of the historical cases, and the main technical field of the historical cases using the preset template; and store the personal introduction information corresponding to the attorney in the attorney information database.

In one embodiment, the above-mentioned apparatus further includes a third creation module configured to obtain the basic information of the customer, where the basic information includes the applicant information; establish the connection with the third-party database storing the patent case information; grab all the patent case data corresponding to applicant information from the third-party database; obtain the historical application information corresponding to the applicant information by using the preset patent analysis model to analyze all the patent case data corresponding to applicant information, where the historical application information may include the technical fields of the patent cases of the historical applications, the historical cooperation agencies, and the historical cooperation attorneys; and store the historical application information corresponding to the customer in the customer information database.

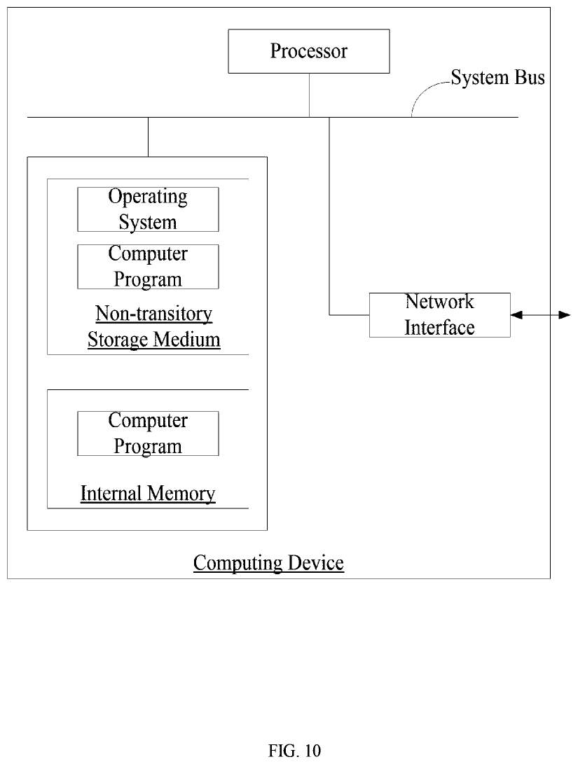

FIG. 10 is a schematic block diagram of the internal structure of a computing device according to an embodiment of the present disclosure. As shown in FIG. 10, the computing device may be a server (e.g., the above-mentioned information processing platform), which includes a processor and a storage connected by a system bus. In which, the storage may include a non-transitory storage medium and an internal memory. The non-transitory storage medium of the computing device stores an operating system, and may further store computer program(s) so that when the computer program(s) are executed by the processor, the processor can be made to realize the above-mentioned personal introduction information generating method, personal introduction information recommending method, or information interaction method. The internal memory may also store with computer program(s) so that when the computer program(s) are executed by the processor, the processor can be made to perform the above-mentioned personal introduction information generating method, personal introduction information recommending method, or information interaction method. Those skilled in the art can understand that the structure shown in FIG. 10 is only a block diagram of a partial structure related to the scheme of the present disclosure, and does not constitute a limitation on the computing device to which the scheme of the present disclosure is applied. The real computing device may include more or fewer components than shown in the figures, or combine certain components or have a different arrangement of components.

A non-transitory computer-readable storage medium storing computer program(s). When the computer program(s) are executed by a processor, the processor is made to perform the steps of the above-mentioned personal introduction information generating method, personal introduction information recommending method, or information interaction method.

A computing device including a storage and a processor. The storage stores computer program(s). When the computer program(s) are executed by a processor, the processor is made to perform the steps of the above-mentioned personal introduction information generating method, personal introduction information recommending method, or information interaction method.

It should be noted that, the above-mentioned personal introduction information generating method, and apparatus, computing device and storage medium using the same as well as the personal introduction information recommending method, and apparatus, computing device and storage medium using the same have the same or corresponding technical features, and the above-mentioned corresponding embodiments may be applicable to each other.

Those of ordinary skill in the art can understand that all or part of the processes in the methods of the forgoing embodiments can be implemented by instructing relevant hardware through a computer program. The program can be stored in a non-transitory computer-readable storage medium. When the program is executed, if may perform the process of the forgoing method embodiments. In which, any reference to memory, storage, database or other medium used in the various embodiments provided in the present disclosure may include non-transitory and/or transitory memory. The non-transitory memory may include read only memory (ROM), programmable ROM (PROM), electrically programmable ROM (EPROM), electrically erasable programmable ROM (EEPROM), or flash memory. The transitory memory may include random access memory (RAM) or external cache memory. By way of illustration but not limitation, RAM may be in various forms such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), rambus direct RAM (RDRAM), direct rambus dynamic RAM (DRDRAM), and rambus dynamic RAM (RDRAM).

The technical features of the forgoing embodiments may be combined arbitrarily. To make the description simple, not all possible combinations of the technical features in the above embodiments are described. However, as long as there is no contradiction in the combination of these technical features, the combination will be considered to be within the scope described in this specification.

The forgoing embodiments only represent several embodiments of the present disclosure, and the descriptions thereof are relatively specific and detailed, but should not be construed as limitations on the scope of the present disclosure. It should be pointed out that, for those skilled in the art, several modifications and improvements can be made without departing from the concept of the present disclosure, and these modifications and improvements are all within the scope of the present disclosure. Therefore, the scope of the present disclosure shall be subject to the appended claims.

What is claimed is:

1. A computer-implemented personal introduction information generating method, comprising:
obtaining basic information of an attorney, wherein the basic information includes identification information of the attorney;
establishing a communicational connection with a third-party database stored with patent case information including the identification information of the attorney;
calculating a historical approval rate related to the attorney within a preset time by processing all patent case data corresponding to the attorney using a preset patent case data processing model;
extracting a preset number of to-be-evaluated patent cases within a preset period in years from all the patent case data corresponding to the attorney;
sending the to-be-evaluated patent cases to a corresponding expert for review to receive a review result returned by the expert; and
generating personal introduction information corresponding to the attorney using a preset template according to the historical approval rate of the attorney and the review result.

2. The method of claim 1, wherein the generating personal introduction information corresponding to the attorney using the preset template according to the historical approval rate of the attorney and the review result comprises:
determining a professional level of the attorney using a preset algorithm according to the historical approval rate of the attorney and the review result; and
generating the personal introduction information corresponding to the attorney using a preset template according to the professional level of the attorney.

3. The method of claim 1, wherein the identification information of the attorney includes a name and surname of the attorney and a practice experience of the attorney, and the practice experience includes one or more agency names each corresponding to one practice period of the attorney; and before the calculating the historical approval rate related to the attorney within the preset time by processing all the patent case data corresponding to the attorney using the preset patent case data processing model, the method further comprises:
extracting all the patent case data corresponding to the attorney from the third-party database according to the name and surname of the attorney and the practice experience of the attorney.

4. The method of claim 2, further comprising:
obtaining historical service evaluation information of the attorney;
the determining the professional level of the attorney using the preset algorithm according to the historical approval rate of the attorney and the review result comprises:
determining the professional level of the attorney using the preset algorithm according to the historical approval rate of the attorney, the review result, and the historical service evaluation information.

5. The method of claim 1, wherein the basic information further comprises agency profession; and the extracting the preset number of to-be-evaluated patent cases within the preset period in years from all the patent case data corresponding to the attorney comprises:
selecting candidate patent case data matching the agency profession from all the patent case data corresponding to the attorney; and
extracting the to-be-evaluated patent cases within the preset period in years from the candidate patent case data.

6. The method of claim 1, wherein the calculating the historical approval rate related to the attorney within the preset time by processing all patent case data corresponding to the attorney using the preset patent case data processing model comprises:
extracting a legal status of each of patent cases in all the patent case data corresponding to the attorney using the preset patent case data processing model, wherein the legal status includes one of approved, examining, denied, and withdrawn, and the patent case data processing model is for determining a regular expression corresponding to the legal status and extracting the legal status of the patent case based on the regular expression;
counting a number of the patent cases with the legal status of approved, a number of the patent cases with the legal status of denied, and a number of the patent cases with the legal status of withdrawn; and
calculating the historical approval rate according to the number of the patent cases, the number of the patent cases, and the number of the patent cases.

7. The method of claim 6, wherein the counting the number of the patent cases with the legal status of approved, the number of the patent cases with the legal status of denied, and the number of the patent cases with the legal status of withdrawn comprises:
counting the number of the patent cases, the number of the patent cases and the number of the patent cases in a preset number of closed cases closest to a current time;
the calculating the historical approval rate according to the number of the patent cases, the number of the patent cases, and the number of the patent cases comprises:
calculating a latest historical approval rate according to the number of the patent cases, the number of the patent cases and the number of the patent cases in the preset number of closed cases closest to the current time.

8. The method of claim 6, wherein the counting the number of the patent cases with the legal status of approved, the number of the patent cases with the legal status of denied, and the number of the patent cases with the legal status of withdrawn comprises:
selecting candidate patent cases each having a filing date within a preset time period from the patent cases in all the patent case data; and
counting the number of the patent cases with the legal status of approved, the number of the patent cases with the legal status of denied, and the number of the patent cases with the legal status of withdrawn in the candidate patent cases;
the calculating the historical approval rate according to the number of the patent cases, the number of the patent cases, and the number of the patent cases comprises:
calculating the historical approval rate corresponding to the preset time period according to the number of the patent cases with the legal status of approved, the number of the patent cases with the legal status of denied, and the number of the patent cases with the legal status of withdrawn in the candidate patent cases.

9. The method of claim 4, wherein the determining the professional level of the attorney using the preset algorithm according to the historical approval rate of the attorney, the review result, and the historical service evaluation information comprises:
obtaining practice duration in years of the attorney and a total number of historical applications of the attorney, and using the practice duration in years and the total number of historical applications as inputs to a weight determination model, wherein the weight determination model is trained based on a deep neural network model;
obtaining a first weight corresponding to the historical approval rate of the attorney, a second weight corresponding to the review result and a third weight corresponding to the historical service evaluation information output by the weight determination model; and
determining the professional level of the attorney according to the historical approval rate and the first weight, the review result and the second weight, and the historical service evaluation information and the third weight.

10. The method of claim 3, wherein the extracting all the patent case data corresponding to the attorney from the third-party database according to the name and surname of the attorney and the practice experience of the attorney comprises:
determining target search conditions according to the name and surname of the attorney and the practice experience of the attorney, wherein the target search conditions include the name and surname of the attorney and the one or more agency names and the corresponding practice period; and
extracting all the patent case data corresponding to the attorney from the third-party database according to the target search conditions.

11. The method of claim 1, further comprising:
obtaining applicants and technical fields of historical patent cases of the attorney by analyzing all the patent case data corresponding to the attorney;
the generating the personal introduction information corresponding to the attorney using the preset template according to the professional level of the attorney comprises:
generating the personal introduction information corresponding to the attorney according to the professional level of the attorney and the applicants and technical fields of the historical patent cases of the attorney.

12. The method of claim 11, wherein the obtaining the applicants and technical fields of the historical patent cases of the attorney by analyzing all the patent case data corresponding to the attorney comprises:
grabbing classification number and abstract of each patent case in all the patent case data corresponding to the attorney, and extracting technical keywords by analyzing the abstract of the patent case; and
determining a technology category corresponding to each patent case in all the patent case data corresponding to the attorney by using the classification number and the technical keywords as inputs of a technology classification model, and using the determined technology category as a technical field label of the patent case.

13. The method of claim 12, wherein the technology classification model includes a first feature model, a second feature model, and a classification model; the first feature model is for determining a first feature vector corresponding to the classification number according to the classification number, the second feature model is for determining a second feature vector corresponding to the technical keywords, and the classification model is for determining the technology category corresponding to the patent case based on the first feature vector and the second feature vector.

14. The method of claim 1, wherein the basic information further includes a qualification certificate number of the attorney; and the obtaining the basic information of the attorney comprises:
obtaining an official practice experience of the attorney according to the qualification certificate number of the attorney;
verifying the basic information of the attorney according to the official practice experience;
performing the step of establishing the communicational connection with the third-party database in response to the verification being successful; and
returning a result of unsuccessful verification in response to the verification being unsuccessful.

15. The method of claim 11, wherein the obtaining the applicants and technical fields of the historical patent cases of the attorney by analyzing all the patent case data corresponding to the attorney comprises:
extracting applicant information in each patent case in all the patent case data corresponding to the attorney, and counting a number of cases corresponding to each of the applicant information;
determining a main applicant according to the number of cases corresponding to each of the applicant information, wherein the main applicant is an applicant with the largest number of cases;
obtaining a technology classification number and technical keywords of each patent case in all the patent case data corresponding to the attorney, and determining the technical field of the patent case according to the technology classification number and technical keywords; and
counting a number of cases corresponding to each of the technical fields, and determining a main technical field according to the number of cases corresponding to each of the technical fields.

16. A non-transitory computer readable storage medium for storing one or more computer programs, wherein the one or more computer programs comprise:
instructions for obtaining basic information of an attorney, wherein the basic information includes identification information of the attorney;
instructions for establishing a communicational connection with a third-party database stored with patent case information including the identification information of the attorney;
instructions for calculating a historical approval rate related to the attorney within a preset time by processing all patent case data corresponding to the attorney using a preset patent case data processing model;
instructions for extracting a preset number of to-be-evaluated patent cases within a preset period in years from all the patent case data corresponding to the attorney;
instructions for sending the to-be-evaluated patent cases to a corresponding expert for review to receive a review result returned by the expert; and
instructions for generating personal introduction information corresponding to the attorney using a preset template according to the historical approval rate of the attorney and the review result.

17. A computing device, comprising:
a processor;
a memory coupled to the processor; and
one or more computer programs stored in the memory and executable on the processor;
wherein, the one or more computer programs comprise:
instructions for obtaining basic information of an attorney, wherein the basic information includes identification information of the attorney;
instructions for establishing a communicational connection with a third-party database stored with patent case information including the identification information of the attorney;
instructions for calculating a historical approval rate related to the attorney within a preset time by processing all patent case data corresponding to the attorney using a preset patent case data processing model;
instructions for extracting a preset number of to-be-evaluated patent cases within a preset period in years from all the patent case data corresponding to the attorney;
instructions for sending the to-be-evaluated patent cases to a corresponding expert for review to receive a review result returned by the expert; and
instructions for generating personal introduction information corresponding to the attorney using a preset template according to the historical approval rate of the attorney and the review result.

18. The computing device of claim 17, wherein the instructions for generating personal introduction information corresponding to the attorney using the preset template according to the historical approval rate of the attorney and the review result comprise:
instructions for determining a professional level of the attorney using a preset algorithm according to the historical approval rate of the attorney and the review result; and
instructions for generating the personal introduction information corresponding to the attorney using a preset template according to the professional level of the attorney.

19. The computing device of claim 17, wherein the identification information of the attorney includes a name and surname of the attorney and a practice experience of the attorney, and the practice experience includes one or more agency names each corresponding to one practice period of the attorney; and the one or more computer programs further comprise:
instructions for extracting all the patent case data corresponding to the attorney from the third-party database according to the name and surname of the attorney and the practice experience of the attorney.

20. The computing device of claim 18, wherein the one or more computer programs further comprise:
instructions for obtaining historical service evaluation information of the attorney;
the instructions for determining the professional level of the attorney using the preset algorithm according to the historical approval rate of the attorney and the review result comprise:
instructions for determining the professional level of the attorney using the preset algorithm according to the historical approval rate of the attorney, the review result, and the historical service evaluation information.
